(19) United States
(12) Patent Application Publication
(10) Pub. No.: US 2002/0032394 A1
(43) Pub. Date: Mar. 14, 2002

(54) Methods, systems, and kits for plaque stabilization

(76) Inventors: Axel Brisken, Fremont, CA (US); Paulina Moore, Menlo Park, CA (US); Robert Zuk, Atherton, CA (US)

Correspondence Address: TOWNSEND AND TOWNSEND AND CREW, TWO EMBARCADERO CENTER, EIGHTH FLOOR, SAN FRANCISCO, CA, 94111-3834, US

(21) Appl. No.: 09/801,571

(22) Filed: Mar. 7, 2001

Related U.S. Application Data
(60) Provisional application No. 60/187,778, filed on Mar. 8, 2000.

(51) Int. Cl. A61H 1/00

(52) U.S. Cl. 601/2

(57) ABSTRACT

Atherosclerotic plaque and blood vessels may be stabilized by directing vibrational energy, typically ultrasonic energy, into the adjacent blood vessel wall. Application of the vibrational energy, optionally in combination with growth factors, growth factor genes, or other substances which enhance growth instability of a fibrotic cap over the plaque, will reduce the risk of rupture of unstable plaque and inhibit the conversion of stable plaque into unstable plaque.

### CROSS-REFERENCES TO RELATED APPLICATIONS

This application claims the benefit of prior provisional application No. 60/187,778 filed on Mar. 9, 2000, under 37 CFR 1.78(a)(3), the full disclosure of which is incorporated herein by reference.

### BACKGROUND OF THE INVENTION

1. Field of the Invention

The present invention relates generally to medical devices and methods. More particularly, the present invention relates to devices and methods for the treatment and stabilization of intravascular plaque.

Coronary artery disease resulting from the build-up of atherosclerotic plaque in the coronary arteries is a leading cause of death in the United States and worldwide. The plaque build-up causes a narrowing of the artery, commonly referred to as a lesion, which reduces blood flow to the myocardium (heart muscle tissue). Myocardial infarction (better known as a heart attack) can occur when an arterial lesion abruptly closes the vessel, causing complete cessation of blood flow to portions of the myocardium. Even if abrupt closure does not occur, blood flow may decrease resulting in chronically insufficient blood flow which can cause significant tissue damage over time.

A variety of interventions have been proposed to treat coronary artery disease. For disseminated disease, the most effective treatment is usually coronary artery bypass grafting where problematic lesions in the coronary arteries are bypassed using external grafts. Focused disease can often be treated intravascularly using a variety of catheter-based approaches, such as balloon angioplasty, atherectomy, radiation treatment, stenting, and often combinations of these approaches.

Plaques which form in the coronaries and other vessels comprise inflammatory cells, smooth muscles cells, cholesterol, and fatty substances, and these materials are usually trapped between the endothelium of the vessel and the underlying smooth muscle cells. Depending on various factors, including thickness, composition, and size of the deposited materials, the plaques can be characterized as stable or unstable. The plaque is normally covered by an endothelial layer. When the endothelial layer is disrupted, the ruptured plaque releases highly thrombogenic constituent materials which are capable of activating the clotting cascade and inducing rapid and substantial coronary thrombosis. Such rupture of an unstable plaque and the resulting thrombus formation can cause unstable angina chest pain, acute myocardial infarction (heart attack), sudden coronary death, and stroke. It has recently been suggested that plaque instability, rather than the degree of plaque build-up, should be the primary determining factor for treatment selection.

While methods have been proposed for detecting unstable plaque in patients, there are few treatment options available when the condition is detected. Drug therapies, such as the use of lipid-lowering drugs, may be of some value but will likely be of limited use when plaque instability has progressed substantially. Catheter-based interventional techniques, such as angioplasty and atherectomy, may exacerbate the problem by inducing rupture of the unstable plaque, causing an immediate and destructive release of thrombogenic materials.

For all these reasons, it would be desirable to provide improved methods, apparatus, and kits for treating patients having unstable intravascular plaque. In particular, it would be desirable to treat those patients in a manner which could stabilize the unstable plaque, rendering it less vulnerable to rupture and subsequent thrombus formation. It would further be desirable if such methods could be applied to apparently stable plaque at risk of becoming unstable, i.e., if such methods were useful prophylactically to treat apparently stable plaque to enhance stability and reduce the risk of conversion to unstable plaque. The methods, devices, and kits of the present invention should preferably be able to treat the unstable (and in some instances stable) plaque with minimum risk of injuring the plaque and inducing plaque rupture. Such methods, apparatus, and kits should be useful with non-invasive, minimally invasive, and invasive procedures to access the target vasculature. Further preferably, the present invention should be useful with all target vasculatures at risk of plaque formation, including the arterial and venous vasculature, the coronary vasculature, the peripheral vasculature, and the cerebral vasculature. At least some of these objectives will be met by the inventions described hereinafter.

2. Description of the Background Art

Ultrasonic energy has been observed to have a number of therapeutic and biological effects. Therapeutic ultrasound has been shown to reduce smooth muscle cell proliferation in vitro (Lawrie et al. (1999) Circulation 99: 2617-2670) and in vivo (WO 99/33391 and copending application Ser. No. 09/223,230). See also U.S. Pat. No. 5,836,896, which asserts that vascular smooth muscle cell migration, viability, and adhesion can be inhibited by the application of intravascular ultrasound. Ultrasound has been shown to increase the compliance of a diseased arterial wall. See, Demer et al. (1991) JACC 18: 1259-62. Therapeutic ultrasound has been shown to promote healing in specific inflammatory diseases. See, e.g., Johannsen et al. (1998) Wound Rep. Reg. 6: 121-126 (leg ulcers); Heckman et al. (1994) J. Bone and Joint Surg. 76A: 26-34 (bone fracture); Huang et al. (1997) J. Rheumatol. 24: 1978-1984 (osteoarthritis); and Forgas-Brockmann et al. (1998) J. Clin. Peridontol. 25: 376-379. Ultrasound has also been used to treat osteonecrosis where it is believed to increase the proliferation of fibroblasts and the synthesis of collagen and other proteins. See, Doan et al. (1999) J. Oral Maxillofac. Surg. 57: 409-419. Ultrasound can promote the healing of tissue inflammation and promote angiogenesis. See, Young and Dyson (1990) Ultrasound in Med. & Bio. 16: 261-269.

The nature of unstable plaque is described in many publications. See, for example, Arroyo and Lee (1998) Can. J. Cardiol. 14 Suppl. B: 11B-13B; Fuster et al. (1998) Vasc. Med. 3: 231-239; Maseri and Sanna (1998) Eur. Heart T. 19 Suppl. K: K2-4; Gyonyosi et al. (1999) Coron. Artery Dis. 10: 211-219; Biasucci et al. (1999) Scand. T. Clin. Invest. 230: 12-22; and Badimon (1999) Circulation 12: 1780-1787.

Ultrasound energy can enhance gene expression in vascular and other cells. See, Lawrie et al. (1999), supra.; and Schratzberger et al. (1999) Circulation (Suppl.), abstract 154, P. 1-31, Abstracts from the 72^{nd} scientific sessions, Atlanta, Georgia. See also, WO 99/33500.

Catheters and transducer systems which may be useful in performing the methods of the present invention are described in copending application Ser. Nos. 09/223,220; 09/223,231; 09/223,225; 09/126,011; 09/255,290; 09/364,616; 09/345,661; 09/343,950; and 09/435,095, the full disclosures of which are incorporated herein by reference.

### BRIEF SUMMARY OF THE INVENTION

The present invention provides for the treatment of vascular atherosclerotic plaque to enhance plaque stability, i.e., reduce the risk of plaque rupture. While particularly suitable for treating plaque which has been determined to be unstable, i.e., at increased risk of abrupt rupture, the methods of the present invention will also be useful for treating plaque which is stable, i.e., determined or believed to be at less risk of abrupt rupture. In the latter case, the present invention would reduce the risk of the stable plaque converting into an unstable plaque. The present invention will find use in all parts of the vasculature which are subject to unstable plaque formation, including both the arterial and venous vasculature, the coronary vasculature, the peripheral vasculature, and the cerebral vasculature.

Treatment according to the present invention is effected by exposing a target region within a blood vessel of the patient to vibrational energy at a mechanical index and for a time sufficient to promote endothelial restoration within the target region. It has been found that the strength of the vibrational energy (as measured by the mechanical index) and the duration of the treatment (as measured by elapsed treatment time, duty cycle, and pulse repetition frequency (PRF)) can be selected to increase the thickness and strength of the thin fibrotic cap which covers the lipid pool which is characteristic of unstable intravascular plaque. It is believed that the vibrational energy may act to increase fibroblast proliferation and collagen and non-collagenous protein synthesis, which in turn increases the thickness of the fibrotic cap. Additionally, it is believed that the vibrational energy may also promote the maturation of the lipid pool within the plaque, further promoting plaque stability and decreasing the risk of plaque rupture.

Optionally, the vibrational treatment methods of the present invention may be combined with the delivery of biologically active substances (bas) which also contribute to the strengthening and thickening of the fibrotic cap overlying the lipid pool. Useful bas's include growth factors and growth factor genes, such as fibroblast growth factor (FGF); tissue inhibitor matrix metalloproteinase (TIMP), and the like. The bas may be administered to the patient in anyway that will deliver the drug to the target region being treated. While localized delivery routes, such as catheter-based drug delivery, will often be preferred, it will also be possible to deliver the drugs systemically through conventional intravasculature, intramuscular, or other administrative routes. The bas may be delivered prior to, during, or subsequent to the vibrational therapy, preferably being delivered prior to or during the vibrational therapy. In particular, it is believed that the vibrational therapy may enhance uptake of the growth-promoting bas, thus providing a synergistic effect where the protein and fibroblast proliferation are enhanced to a level greater than could be achieved using either the vibrational therapy or the bas therapy alone. Prior to treatment, a patient will usually be evaluated to determine both the extent of atherosclerotic plaque and the degree of stability of that plaque. Often, the patient will have a symptom which will trigger the evaluation, such as angina, chest pain, or the like. In other cases, however, the patient may be asymptomatic but at significant risk of cardiovascular disease. For example, the patient may have hypercholesterolemia, diabetes, family history, suffer from risk factors such as smoking, or the like.

The presently available evaluations to determine the presence of unstable plaque are described in the medical literature. For example, radiolabeled agents which preferentially deposit in lipid-rich plaque may be administered to the patient and thereafter detected. See, for example, Elmaleh et al. (1998) Proc. Natl. Acad. Sci. USA 95:691-695; Vallabhajosula and Fuster (1997) J. Nucl. Med. 38:1788-1796); Demos et al. (1997) J. Pharm. Sci. 86:167-171; Narula et al. (1995) Circulation 92: 474-484; and Lees et al. (1998) Arteriosclerosis 8:461-470. U.S. Pat. No. 4,660,563, describes the injection of radiolabeled lipoproteins into a patient where the lipoproteins are taken up into regions of arteriosclerotic lesions to permit early detection of those lesions using an external scintillation counter.

Once the nature and extent of the atherosclerotic plaque load has been determined, a decision can be reached as to whether the patient should be treated by the methods of the present invention to enhance plaque stability. For example, when the plaque is determined to be unstable, treatment according to the methods of the present invention will usually be warranted. Even when the plaque is believed to be stable, treatment may be warranted if the plaque load is particularly heavy or it is believed that the plaque is at risk of converting to unstable plaque in the future. If the plaque is determined to be stable, but the plaque load significant (e.g., occluding over 70% of the available luminal area), then conventional treatments, such as angioplasty, atherectomy, CABG, or the like, may be warranted.

Once it is determined that therapy according to the present invention is to be performed, the particular motive therapy can be selected among different approaches. In a first approach, exposing the blood vessel to vibrational energy comprises positioning an interface surface on or coupled to a vibrational transducer within the blood vessel at a target site within the target region. The transducer is driven to direct vibrational energy from the interface surface against the blood vessel wall to enhance growth and stabilization of the fibrotic cap over the lipid-rich unstable plaque. Alternatively, the exposing step may comprise positioning an interface surface on or coupled to a vibrational transducer against a tissue surface which is disposed over the target region of the blood vessel, e.g., over the epicardium or pericardium of the heart, or over a skin surface, such as the leg, when treating the peripheral vasculature. The transducer may be then driven to direct vibrational energy from the interface surface through overlying tissue and against the blood vessel wall. When employing such external techniques, the vibrational energy may be directed toward a beacon or other signal located within the target region. As a third alternative, an interface surface on or coupled to a vibrational transducer may be positioned within a second blood vessel located near the target region of the target blood vessel. For example, coronary and other veins are frequently located a short distance from a corresponding artery. By placing the interface surface within a vein, a vibrational energy can be directed to an adjacent artery for treatment of disease within that artery. As with the prior cases, the transducer will then be driven to direct vibrational energy from the interface surface, in this case present within the second blood vessel, through tissue between the second blood vessel and the target blood vessel, and into the blood vessel wall of the target blood vessel. As a still further alternative, an interface surface coupled on or to a vibrational transducer may be positioned within a heart chamber to treat a coronary artery positioned over the heart chamber. The transducer will be driven to direct vibrational energy outwardly from the heart chamber through the myocardium and into the coronary artery in order to treat the coronary wall. As a fifth alternative, tissue overlying a target blood vessel may be surgically opened to directly expose the blood vessel. An interface surface on or coupled to a vibrational transducer may then be directly engaged against the wall of the target blood vessel (or over some thin layer of tissue or other structures which may remain), and the transducer driven to direct vibrational energy into the target region of the exposed target vessel.

Mechanical index and duration of the treatment are the most important treatment perimeters. The mechanical index (MI) is a function of both the intensity and the frequency of the vibrational energy produced, and is defined as the peak rarefactional pressure (P) expressed in megaPascals divided by the square root of frequency (f) expressed in megaHertz:

$$MI = \frac{P}{\sqrt{f}}$$

The duration of treatment is defined as the actual time during which vibrational energy is being applied to the arterial wall. Duration will thus be a function of the total elapsed treatment time, i.e., the difference in seconds between the initiation and termination of treatment; burst length, i.e., the length of time for a single burst of vibrational energy; and pulse repetition frequency (PRF). Usually, the vibrational energy will be applied in short bursts of high intensity (power) interspersed in relatively long periods of no excitation or energy output. An advantage of the spacing of short energy bursts is that heat may be dissipated and operating temperature reduced.

Broad, preferred, and exemplary values for each of these parameters is set forth in the following table.

PREFERRED AND EXEMPLARY
TREATMENT CONDITIONS

| | | | EXEM- |
|---|---|---|---|
| | BROAD | PREFERRED | PLARY |
| Mechanical Index (MI) | 0.1 to 50 | 0.2 to 10 | 0.5 to 5 |
| Intensity (SPT, | 0.01 to 100 | 0.1 to 20 | 0.5 to 5 |
| W/cm²) | | | |
| Frequency (kHz) | 100 to 5000 | 300 to 3000 | 500 to 1500 |
| Elapsed Time (sec.) | 10 to 900 | 30 to 500 | 60 to 300 |
| Duty Cycle (%) | 0.1 to 100 | 0.2 to 10 | 0.2 to 2 |
| Pulse Repetition | 10 to 10,000 | 100 to 5000 | 300 to 3000 |
| Frequency (PRF)(Hz) | | | |

The vibrational energy will usually be ultrasonic energy applied intravascularly or externally using an intravascular catheter or other device having an interface surface thereon, usually near its distal end. The catheter will be intravascularly introduced so that the interface surface lies proximate the target region to be treated. External applicators may also be used as described below.

For intravascular treatment, the ultrasonic or other vibrational energy will be directed radially outward from an interface surface into a target site or region within the arterial wall. By “radially outward,” it is meant that the compression wave fronts of the vibrational energy will travel in a radially outward direction so that they enter into the arterial wall in a generally normal or perpendicular fashion. It will generally not be preferred to direct the vibrational energy in a direction so that any substantial portion of the energy has an axial component.

In most instances, it will be desirable that the vibrational energy be distributed over an entire peripheral portion or section of the blood vessel wall. Such peripheral portions will usually be tubular having a generally circular cross-section (defined by the geometry of the arterial wall after angioplasty, stenting, or other recanalization treatment) and a length which covers at least the length of the treated arterial wall. While it may be most preferred to distribute the vibrational energy in a peripherally and longitudinally uniform manner, it is presently believed that complete uniformity is not needed. In particular, it is believed that a non-uniform peripheral distribution of energy over the circumference of the arterial wall will find use, at least so long as at least most portion of walls are being treated.

Even when vibratory forces are spaced-apart peripherally and/or longitudinally, the effective distribution of vibrational energy will be evened out by radiation pressure forces arising from the absorption and reflection of ultrasound on the circumferential walls of the arterial lumen, thereby producing a uniform effect due to the fact that the tension in the wall of the lumen will tend to be equal around its circumference. Accordingly, a uniform inhibitory effect can occur even if there is some variation in the intensity of the ultrasound (as in the case of the non-isotropic devices described hereinafter). This is due to the fact that the tension around the circumference of the lumen will be equal in the absence of tangential forces.

Usually, the interface surface will be energized directly or indirectly by an ultrasonic transducer which is also located at or near the distal tip of the catheter. By direct, it is meant that the surface is part of the transducer. By indirect, it is meant that the transducer is coupled to the surface through a linkage, such as a resonant linkage as described hereinafter. Alternatively, energy transmission elements may be provided to transfer ultrasonic energy generated externally to the catheter to the interface surface near its distal tip. As a further alternative, the ultrasonic energy may be generated externally and transmitted to the target region by focusing through the patient's skin i.e., without the use of a catheter or other percutaneously introduced device. Such techniques are generally referred to as high intensity focused ultrasound (HIFU) and are well described in the patent and medical literature.

When employing an intravascularly positioned interface surface, the surface may directly contact all or a portion of the blood vessel wall within the target region in order to effect direct transmission of the ultrasonic energy into the wall. Alternatively, the interface surface may be radially spaced-apart from the blood vessel wall, wherein the ultrasonic energy is transmitted through a liquid medium disposed between the interface surface and the wall. In some cases, the liquid medium will be blood, e.g., where the interface surface is within an expansible cage or other centering structure that permits blood flow therethrough. In other cases, the liquid medium may be another fluid either contained within a balloon which circumscribes the transducer and/or contained between axially spaced-apart balloons which retain the alternative fluid. Suitable ultrasonically conductive fluids include saline, contrast medium, and the like. In some cases, the medium surrounding the interface surface will include drugs, nucleic acids, or other substances which are intended to be intramurally delivered to the blood vessel wall. In particular, the delivery of nucleic acids using intravascular catheters while simultaneously directly inhibiting cell proliferation and hyperplasia is described in co-pending application Ser. No. 60/070,073, assigned to the assignee of the present application, filed on the same day as the present application, the full disclosure of which is incorporated herein by reference.

Ultrasonic or other vibrational excitation of the interface surface may be accomplished in a variety of conventional ways. The interface surface may be an exposed surface of a piezoelectric, magnetostrictive, or other transducer which is exposed directly to the environment surrounding the catheter. Alternatively, the transducer may be mechanically linked or fluidly coupled to a separate surface which is driven by the transducer, optionally via a resonant linkage, as described in co-pending application Ser. Nos. 08/565,575; 08/566,740; 08/566,739; 08/708,589, 08/867,007; and 09/223,225, the full disclosures of which have previously been incorporated herein by reference. Preferably, the interface surface may be vibrated in a generally radial direction in order to emit radial waves into the surrounding fluid and/or directly into the tissue. Alternatively, the interface surface may be vibrated in a substantially axial direction in which case axial waves may be transmitted into the surrounding environment and/or directly into the blood vessel wall.

The present invention still further comprises kits including a catheter or other applicator having an interface surface. The kits further include instructions for use according to any of the methods set forth above. Optionally, the kits may still further include a conventional package, such as a pouch, tray, box, tube, or the like. The instructions may be provided on a separate printed sheet (a package insert setting forth the instructions for use), or may be printed in whole or in part on the packaging. A variety of other kit components, such as drugs to be delivered intravascularly through the catheter, could also be provided. Usually, at least some of the components of the system will be maintained in a sterile manner within the packaging.

### BRIEF DESCRIPTION OF THE DRAWINGS

FIG. 1 is a schematic illustration of a blood vessel having unstable plaque.

FIG. 2 illustrates a catheter having vibrational interface surfaces disposed within a blood vessel to treat unstable plaque.

FIG. 3 illustrates use of an external applicator for directing vibrational energy to treat unstable plaque within a blood vessel.

FIG. 4 illustrates the use of an external applicator for applying vibrational energy to treat unstable plaque within a blood vessel having a catheter carrying a beacon transducer within a lumen of the blood vessel.

FIG. 5 illustrates treatment of unstable plaque within a blood vessel using an intravascular catheter positioned in an adjacent blood vessel.

FIG. 6 illustrates use of an external applicator for applying vibrational energy according to the methods of the present invention to treat a blood vessel which has been surgically exposed.

FIG. 7 illustrates use of an intracardiac catheter for directing ultrasonic energy from an interface surface on the catheter outwardly through the myocardium to treat a blood vessel on the outer surface of the heart.

FIG. 8 illustrates a kit incorporating a catheter or other treatment device and instructions for use according to the present invention.

### DESCRIPTION OF THE SPECIFIC EMBODIMENTS

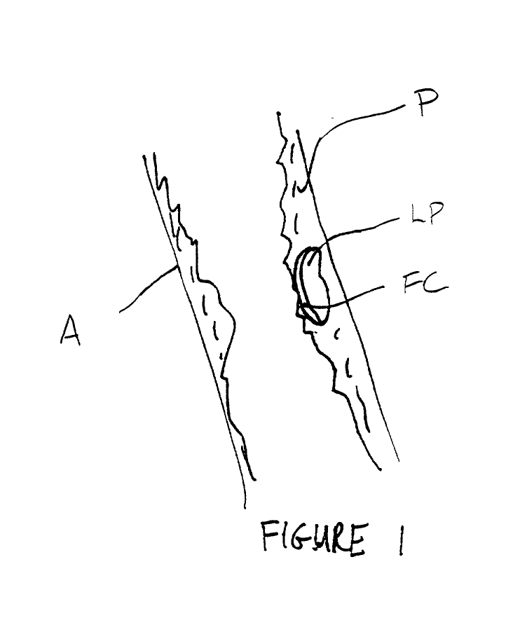

FIG. 1 illustrates a longitudinal cross-section of a blood vessel, in this case an artery A having a region of plaque including heterogeneous plaque P within an unstable region comprising a lipid pool LP covered by a fibrotic cap FC. The nature of the plaque P and location of the unstable regions within the plaque may be determined by the techniques described above.

Once it is determined that the patient suffers from unstable plaque, or it is determined that the patient has apparently stable plaque which might benefit from stability enhancement, the patient may be treated by exposing the plaque, and in particular unstable regions of the plaque, to vibrational energy with the treatment parameters described above. Usually, the entire region of plaque which has been identified will be treated, although as diagnostic capabilities become more advanced, it may be desirable to treat only the regions of instability within the plaque.

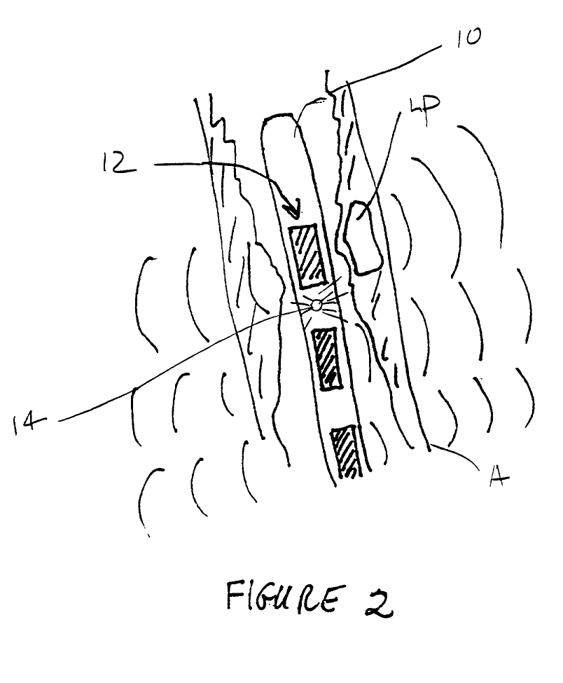

For example, referring to FIG. 2, an intravascular catheter 10 may be introduced so that one or more vibrational interface surfaces 12 at its distal end may be located adjacent a region of unstable plaque within the blood vessel A. The vibrational interface surfaces may be disposed directly over the suitable transducer or may be vibrated using a transmission element which extends partly or entirely through the catheter. In either case, the vibrational interface surface is excited to emit vibrational energy in a generally radial direction away from the catheter and into the blood vessel wall. The energy will be delivered according to the parameters described above, and will act to enhance plaque stability according to the mechanisms described above. Optionally, a bas selected to further enhance stability of the fibrotic cap may be introduced through a port 14 on the catheter itself or systemically to the patient. Further optionally, the catheter 12 may include a linear array of such transducers, permitting treatment of a discrete length of the blood vessel simultaneously. Alternatively or additionally, the catheter 12 may be axially translated within the blood vessel A in order to treat an extended length of disease. Further optionally, the catheter may be rotated in order to enhance uniformity of the treatment.

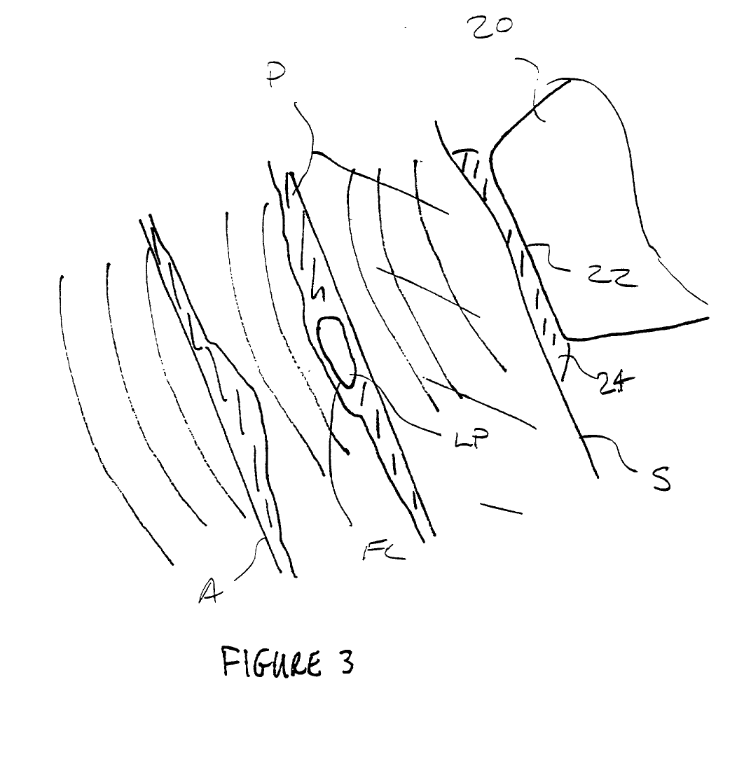

Referring now to FIG. 3, the target artery A or other blood vessel may be treated transcutaneously by engaging an external applicator 20 having a vibrational interface surface 22 directly against a patient's skin S or other tissue surface (e.g., a surgically exposed region). The applicator 20 will preferably be a wide field applicator, such as that described in copending application Ser. No. 09/223,225, the disclosure of which has previously been incorporated by reference. Such external treatments from the patient's skin will be useful primarily with treatment of the carotid artery in the neck and some peripheral arteries and veins, usually in the legs. The external applicator 20 will be applied against the skin S, usually using an acoustic coupling gel 24 and the ultrasonic energy will be applied inwardly so that it engages the region of unstable plaque within the artery A to enhance the strength and stability of the fibrotic cap FC.

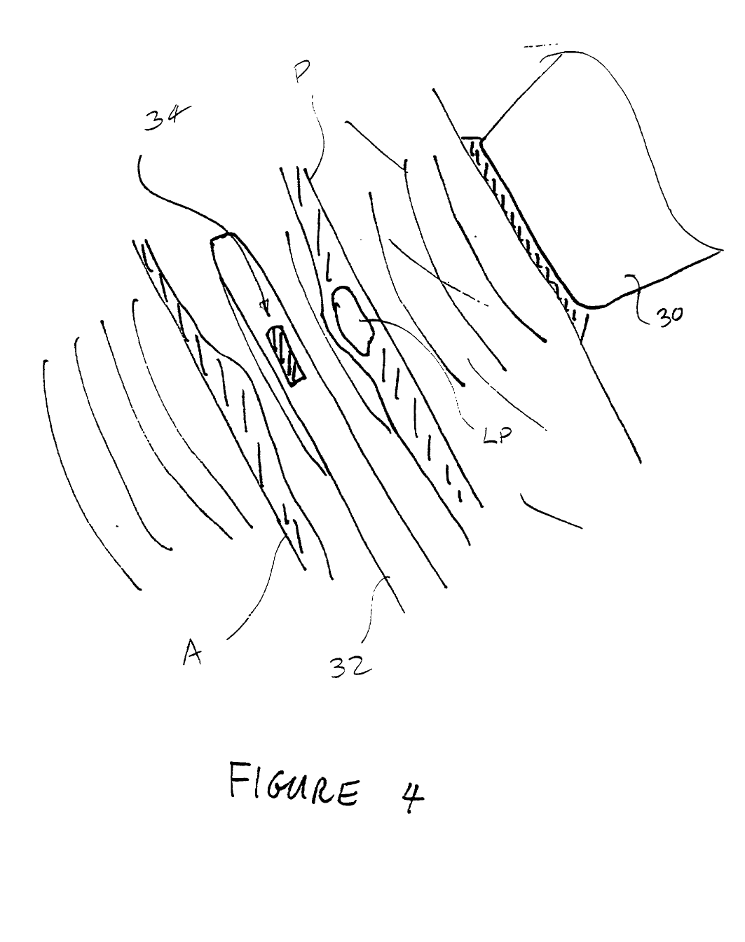

Referring now to FIG. 4, transcutaneous treatment of an underlying artery A could also be achieved using a two-dimensional transducer 30 (not a wide field device). Alignment of the device with the plaque to be treated can be enhanced using a catheter 32 having a directional beacon 34. The beacon will be configured to detect the ultrasonic energy entering the blood vessel and to permit a determination of the strength of the energy. The user could then reposition the external applicator 30 until the ultrasonic energy reaching a particular target site defined by the beacon 34 is maximized. The use of a beacon is further advantageous since it permits an actual determination of the vibrational dose reaching the target region.

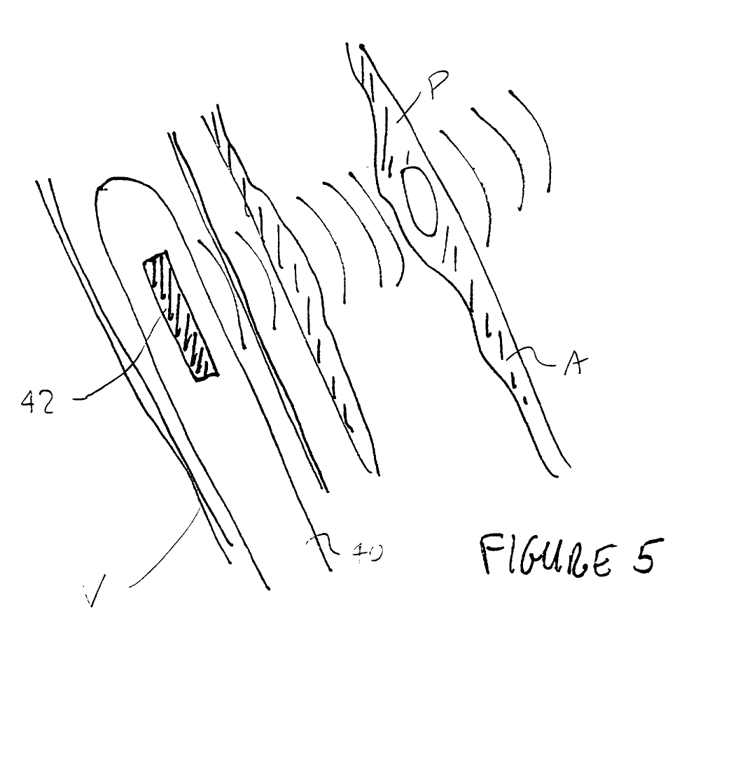

Referring now to FIG. 5, plaque P within an artery A can be treated by introducing a catheter 40 having a suitable vibratory interface surface 42 thereon into a vein V adjacent to the artery. Most arteries in the human body are in close proximity to corresponding veins, usually being parallel. By placing the treatment catheter 40 into the adjacent vein, a therapeutic dose of the vibrational energy can be directed across from the vein into the arterial wall to effect the desired vibrational treatment. The catheter delivering the vibrational energy may have a symmetric, radially outward field of delivery. Alternatively, the vibrational energy may be directional and the catheter may be oriented, typically being rotated about its central axis, until the energy is directed specifically toward the treatment region within the plaque P within the artery A. It is likely that angiographic guidance will be necessary in order to properly orient the catheter 40 and vibrational surface 42 relative to the adjacent artery A.

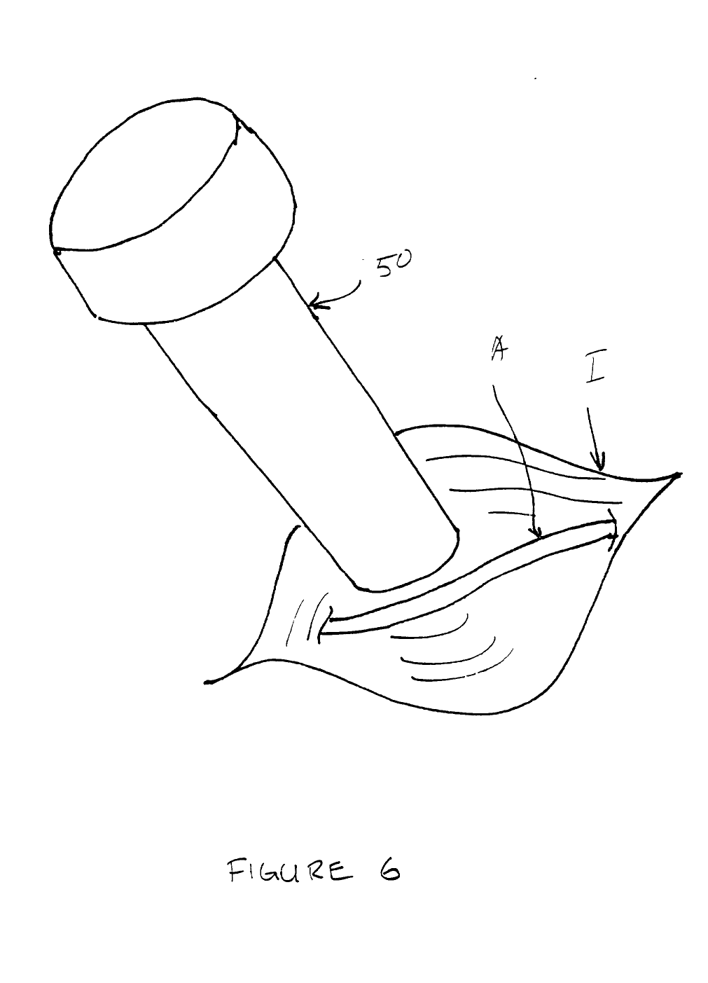

Referring now to FIG. 6, in some cases, it may be desirable to surgically expose an artery A, e.g., through an incision I in the skin. An external applicator can then be introduced through the opening of the incision I and disposed directly against the exposed wall of the artery, or in some cases, over a thin remaining layer of tissue. For example, in treating the coronary arteries, where the applicator 50 might be exposed through an opening between adjacent ribs, the pericardium may remain over the artery and the vibrational energy introduced through the pericardium.

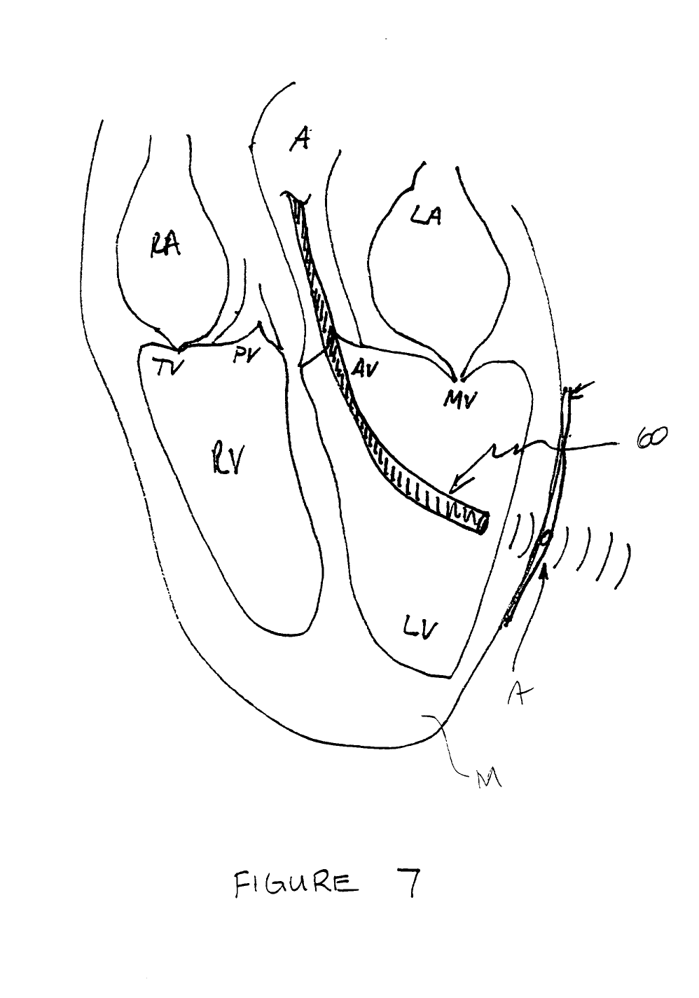

Referring now to FIG. 7, coronary arteries can be treated via an intracardiac approach. A catheter 60 may be introduced to a heart chamber, such as the left ventricle LV during an appropriate intravascular route. In the case of the left ventricle, the catheter 60 could be introduced through the aorta and the aortic valve into the left ventricle. The catheter 60 would preferably be a steerable catheter, such as those used for intracardiac oblation for the treatment of arrhythmias, and would be directed to a desired target region within the artery A. A vibrational interface surface on the catheter could then be energized to deliver vibrational energy outwardly through the myocardium M and into the blood vessel wall. As shown in FIG. 7, the catheter 60 has a vibrational interface surface which directs the energy axially from the catheter. It would also be possible to employ vibrational interface surfaces which direct the energy laterally or radially, although in such instances the catheter would have to be oriented differently than illustrated in FIG. 7.

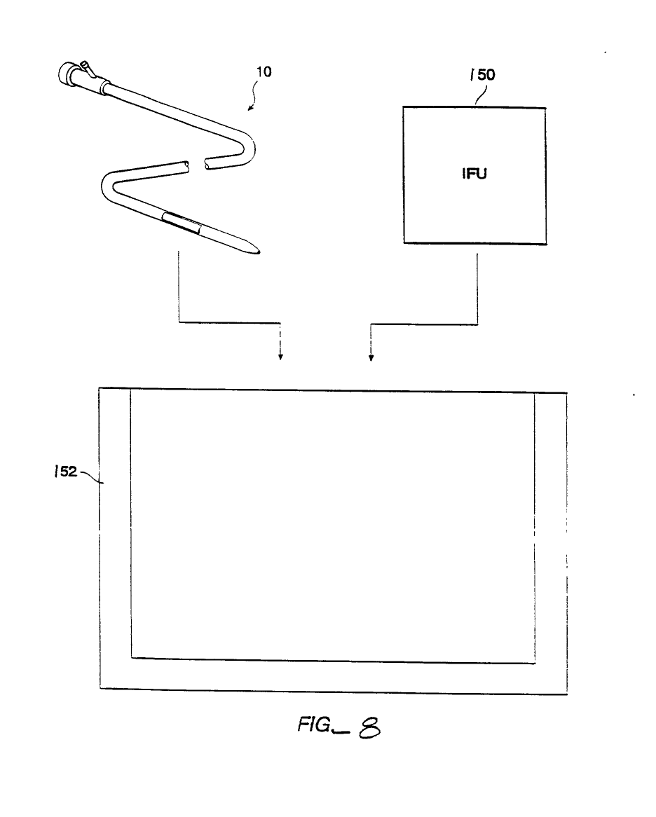

The catheters 10 or other applicators of the present invention will usually be packaged in kits, as illustrated in FIG. 8. In addition to the catheter 10, such kits will include at least instructions for use 150 (IFU). The catheter and instructions for use will usually be packaged together within a single enclosure, such as a pouch, tray, box, tube, or the like, 152. At least some of the components may be sterilized within the container. Instructions for use 150 will set forth any of the methods described above. The kits may include a variety of other components, such as drugs or other agents to be delivered by the catheter to enhance the therapy.

While the above is a complete description of the preferred embodiments of the invention, various alternatives, modifications, and equivalents may be used. Therefore, the above description should not be taken as limiting the scope of the invention which is defined by the appended claims.

What is claimed is:

1. A method for promoting endothelial integrity in blood vessels, said method comprising:
exposing a target region within the blood vessel of a patient to vibrational energy at a mechanical index and for a time sufficient to promote endothelial restoration within the target region.

2. A method as in claim 1, further comprising selecting a patient having a blood vessel target region characterized by unstable plaque.

3. A method as in claim 1, further comprising selecting a patient having a blood vessel target region characterized by stable plaque.

4. A method as in claim 2 or 3, further comprising imaging the blood vessel to determine the nature of plaque within the blood vessel.

5. A method as in claim 1, wherein the patient is treated with the vibrational energy prior to plaque rupture.

6. A method as in claim 1, wherein exposing the blood vessel comprises:
positioning an interface surface on or coupled to a vibrational transducer within the blood vessel at the target site; and
driving the transducer to direct vibration energy from the interface surface against the blood vessel wall.

7. A method as in claim 1, wherein exposing the blood vessel comprises:
positioning an interface surface on or coupled to a vibrational transducer against a tissue surface over the target region of the blood vessel; and
driving the transducer to direct vibrational energy from the interface surface against the blood vessel wall.

8. A method as in claim 7, further comprising positioning the interface surface to direct the vibrational energy toward a beacon signal located at the target region within the blood vessel.

9. A method as in claim 1, wherein exposing the blood vessel comprises:
positioning an interface surface on or coupled to a vibrational transducer within a second blood vessel located near the target region of the target blood vessel; and
driving the transducer to direct vibrational energy from the interface surface through tissue between the second blood vessel and the target blood vessel to the target region within the target blood vessel.

10. A method as in claim 1, wherein exposing the blood vessel comprises:
positioning an interface surface coupled on or to a vibrational transducer within a heart chamber, wherein the target blood vessel is a coronary artery positioned over the heart chamber;
driving the transducer to direct vibrational energy outwardly from the heart chamber, through the myocardium, and into the coronary artery.

11. A method as in claim 1, wherein exposing the blood vessel comprises:
surgically opening tissue overlying the target blood vessel;
positioning an interface surface on or coupled to a vibrational transducer over the exposed target blood vessel; and
driving the transducer to direct vibrational energy into the target region of the exposed target vessel.

12. A method as in claim 1, further comprising administering to the target region an amount of biologically active substance (bas) sufficient to promote endothelial restoration within the target region.

13. A method as in claim 12, wherein the bas is administered at least prior to exposing the target region to vibrational energy.

14. A method as in claim 12, wherein the bas is administered at least during exposure of the target region to vibrational energy.

15. A method as in claim 12, wherein the bas is administered at least after exposure of the target region to vibrational energy.

16. A method as in claim 12, wherein the bas is selected from the group consisting of growth factors, growth factor genes, tissue inhibitor metalloproteinase (TIMP), and TIMP gene.

17. A method as in any of claims 1-16, wherein the vibrational energy comprises compression waves which travel to the arterial wall in substantially radial direction.

18. A method as in any of claims 1-16, wherein the vibrational energy does not cause significant cavitation in a wall of the artery.

19. A method as in any of claims 1-16, wherein the vibrational energy causes a temperature rise below 10° C. in the wall of the artery.

20. A method as in any of claims 1-16, wherein the vibrational energy has a frequency in the range from 100 kHz to 5 MHz.

21. A method as in claim 20, wherein the intensity is in the range from 0.01 W/cm² to 100 W/cm².

22. A method as in claim 21, wherein the frequency and intensity are selected to produce a mechanical index at the neointimal wall in the range from 0.1 to 50.

23. A method as in any of claims 1-16, wherein the vibrational energy is directed against the arterial wall with a pulse repetition frequency (PRF) in the range from 10 Hz to 10 kHz.

24. A method as in any of claims 1-16, wherein the energy is directed against the arterial wall with a duty cycle in the range from 0.1 to 100 percent.

25. A kit comprising:
a catheter having an interface surface; and
instructions for use according to any of claims 1-6, 9, 10, and 12-16.

26. A kit comprising:
an external vibrational source having an interface surface; and
instructions for use according to any of claims 1-5, 8, and 11-16.
